(19) United States
(12) Patent Application Publication
(10) Pub. No.: US 2002/0106512 A1
(43) Pub. Date: Aug. 8, 2002

(54) SURFACE-MODIFIED MAGNETITE PARTICLES AS WELL AS PREPARATION PROCESSES AND USES THEREOF

(76) Inventors: AKIRA NAKAMURA, YAMAGUCHI-KEN (JP); AKIRA YOSHIMI, YAMAGUCHI-KEN (JP)

Correspondence Address: CUSHMAN DARBY & CUSHMAN, IP GRP OF PILLSBURY MADISON & SUTRO LLP, 1100 NEW YORK AVENUE NW, NINTH FLOOR EAST TOWER, WASHINGTON, DC, 200053918

(21) Appl. No.: 09/305,757

(22) Filed: May 6, 1999

(30) Foreign Application Priority Data
May 7, 1998 (JP) 124790/1998

(51) Int. Cl. B32B 3/00

(52) U.S. Cl. 428/404

(57) ABSTRACT

Magnetite particles having high electric charge, low stirring torque and low adsorbed moisture content as compared with conventional magnetite particles for magnetic toners are prepared. The process comprises slurrying wet-synthesized magnetite particles, then adjusting the pH successively with a given amount of a water-soluble aluminium salt and a given amount of colloidal silica. Optionally, the particles are further covered with a silicone oil and/or coupling agent. Then, filtration, washing and drying take place.

### BACKGROUND OF THE INVENTION

The present invention relates to surface-modified magnetite particles well-suitable for use in electrophotographic magnetic toner or the like, as well as preparation processes and uses thereof.

A method for developing electrostatic latent images is known which uses the so-called one-component magnetic developer containing magnetic fine powder in a cohesive resin without carrier. As compared with the so-called two-component developer using a carrier, this type of toner has the disadvantage that the image density tends to be lowered especially in environments of high temperature and high humidity because of the low absolute charge on toner particles.

An attempt has been made to improve the electric charge on toner particles by placing silica particles known as a material with highly negative charge on the surfaces of magnetite particles to improve electric charge and flowability of the magnetite particles.

For example, JPA No. 213620/93 discloses spherical magnetite powder containing a silicon component incorporated therein and a silicon component exposed on the surface. JPA Nos. 139544/79, 53660/86, 73367/90, 162651/92 and 110598/95 disclose processes for depositing and/or applying a hydroxide or oxide of silicon or aluminium or both on the surfaces of magnetite particles in various forms generated by a wet process.

However, these use water-soluble silicates such as sodium silicate as silicon sources, so that the precipitating silica appears in a fine and amorphous state rich in hydroxyl groups. This causes inconveniences in the processes because even addition of a water-soluble aluminium salt is ineffective but the elementary aluminium is incorporated into the network structure without staying on the surface of amorphous silica to show high thixotropy during the filtration step.

It is generally known that current flows by tunnel effect at grain boundaries of ceramics when the thickness of the insulating layer is small. Therefore, the insulating layer of silica must be thick in order to increase the resistance of magnetite particles to enhance the absolute electric charge. Thus, the filtrability is lowered and the preparation becomes difficult if a water-soluble silicate is used to cover the particles with silica to the extent that the resistance is enhanced.

On the other hand, a thick insulating layer can be made on the surfaces of magnetite particles without damaging filtrability if colloidal silica is used as a silica source. For example, JPA Nos. 280301/90, 43687/94 and 267646/95 succeeded in obtaining intended particles by adsorbing colloidal silica onto the surface of magnetic powder containing zinc. However, these methods merely attain electrostatic bond between colloidal silica and magnetic particle surfaces via zinc compounds, but silica particles are readily separated by mechanical shock such as friction to reduce the effect by half. Moreover, zinc compounds are doped within the base material magnetite particles so that they are relatively conductive and less effective to enhance insulation.

JPA No. 36538/78 discloses a process comprising depositing colloidal silica on particle surfaces of iron oxide (Fe₂O₃), and then further depositing aluminium hydroxide on those surfaces using a water-soluble aluminium salt or aluminium hydroxide colloid. However, this process can not be applied to magnetite for use in one-component developers, because aluminium hydroxide with high positive charge deposits on particle surfaces.

An object of the present invention is to provide magnetite particles having a high electric resistance, a high electric charge and a low stirring torque, which can be suitably used in one-component magnetic developers, in order to solve the above problems.

### SUMMARY OF THE INVENTION

Accordingly, surface-modified magnetite particles of the present invention are characterized in that the surface of magnetite particles are covered with a first layer containing hydrated alumina or alumina sol and the surface of said first layer is further covered with a second layer of silica particles derived from colloidal silica. Said first layer may contain a compound formed by a reaction with the silica element of said second layer. Said first layer, for example, may have thickness of 0.001-0.05 μm. Said second layer is preferably a monolayer adsorption of silica particles.

In said surface-modified magnetite particles, the electric resistance of powder is preferably 1×10⁵ Ω·cm or more.

In said surface-modified magnetite particles, the electric charge of powder is desirably −10 μc/g or less.

In said surface-modified magnetite particles, the stirring torque is preferably 0.016 kg·m or less. As used herein, the stirring torque is evaluated by measuring the stirring torque when 100 ml of powder is stirred in a mixing chamber (corresponding to the absorbed meter mixing chamber defined in JIS K6221-1982 available from Flontec), and it provides an indicator of flowability of powder wherein a lower stirring torque is indicative of better flowability.

In the surface-modified magnetite particles of the present invention, the surface of said second layer is covered with a layer of a silicone oil and/or coupling agent preferably to have an adsorbed moisture content of 0.4% or less.

A process for preparing surface-modified magnetite particles of the present invention comprises slurrying magnetite particles with water, then adding a water-soluble aluminium salt or alumina sol at 0.1-3% by weight expressed as alumina to adjust pH to 6-7 and further adding colloidal silica at 0.5-10% by weight expressed as silica to adjust pH to 6-7, followed by filtration, washing and drying.

In the process of the present invention, the particle surfaces may be further covered with a silicone oil and/or coupling agent after said colloidal silica is added to adjust pH.

Surface-modified magnetite particles of the present invention can also be used to prepare a digital or analog electrophotographic magnetic toner, resin-dispersed carrier or resin composition.

Surface-modified magnetite particles of the present invention can form a thick insulation layer without affecting filtrability and ensure high negative electric charge and good flowability, because the surfaces of the magnetite particles are successively covered with a first layer containing hydrated alumina or alumina sol and a second layer of silica particles derived from colloidal silica. Furthermore, constituents in the covering layers react with each other to form a compound, resulting in firm bonding to prevent separation of the covering layers.

Magnetite particles of the present invention can be suitably used in one-component magnetic developers because they have an electric resistance of 1×10⁵ Ω·cm or more and an electric charge of powder of −10 μc/g or less.

Magnetite particles of the present invention can be suitably used in one-component magnetic developers because they have excellent flowability as indicated by a stirring torque of 0.016 kg·m or less.

Magnetite particles of the present invention can be used in one-component magnetic developers with excellent environmental stability because they have been treated with a silicone oil and/or coupling agent to have a low adsorbed moisture content of 0.4% or less.

Processes for preparing surface-modified magnetite particles of the present invention can readily and reliably provide surface-modified magnetite particles characterized as above.

Surface-modified magnetite particles of the present invention can be suitably used in electrophotographic magnetic toners, resin-dispersed carriers and resin compositions because they have high electric resistance and electric charge, low stirring torque and low adsorbed moisture content.

### DETAILED DESCRIPTION OF THE INVENTION

Surface-modified magnetite particles of the present invention will be further explained below.

Surface-modified magnetite particles of the present invention can be specifically prepared in the following manner.

Wet-synthesized magnetite particles are slurried with water to 100-200 g/L, then adding a water-soluble aluminium salt or alumina sol at 0.1-3% by weight expressed as alumina to adjust pH to 6-7 and further adding colloidal silica at 0.5-10% by weight expressed as silica to adjust pH to 6-7. Optionally, a silicone oil and/or coupling agent may be further applied. Then, filtration, washing and drying take place.

The base material magnetite particles here are not specifically limited, but preferred are those obtained by wet-oxidizing ferrous hydroxide in air and having an average particle diameter of about 0.02-0.5 μm. Said magnetite particles may contain Al, Si, Zn, Mn, Cu, Ni, Co, Mg, Cd, Cr, V, Mo, Ti, Sn or other elements or oxides thereof to improve their characteristics. The particle shape is not specifically limited including spheres, hexahedrons, octahedrons or polyhedrons, but preferably spherical when the electric resistance, electric charge, stirring torque and other characteristics of powder are respected as in the present invention.

Suitable water-soluble aluminium includes aluminium sulfate, aluminium nitrate, aluminium chloride, basic aluminium chloride, sodium aluminate, etc., preferably aluminium sulfate and sodium aluminate.

Suitable alumina sol includes any hydrated alumina having a size of 5 to 200 μm.

Said water-soluble aluminium or alumina sol is added at 0.1-3% by weight, preferably 0.2-1.5% by weight expressed as alumina. The amount less than 0.1% by weight is unpreferable because colloidal silica applied thereon is readily separated. The amount greater than 3% by weight is also unpreferable because moisture content increases from aluminium hydroxide to affect environmental stability for use in toners.

Any colloidal silica having an average particle diameter of 4-90 μm may be used, but preferred are those having a particle diameter ratio to the base material magnetite of 1:5-1:100 when the electric resistance, electric charge, stirring torque and other characteristics of powder are respected as in the present invention.

Colloidal silica is added at 0.5-10% by weight, preferably 1-7% by weight expressed as silica. The amount less than 0.5% by weight is unpreferable because the electric resistance is not sufficiently enhanced. The amount greater than 10% by weight is also unpreferable because silica is excessive and adsorbed no more.

The pH is adjusted with an alkali or acid. The alkali includes aqueous solutions of alkali metal hydroxides such as sodium hydroxide and potassium hydroxide or alkali earth metal hydroxides such as magnesium hydroxide and calcium hydroxide. The acid includes nitric acid, hydrochloric acid, sulfuric acid, acetic acid, etc.

Suitable silicone oils include methyl silicone oils, dimethyl silicone oils, alkyl-modified silicone oils, fatty acid-modified silicone oils, polyoxyalkyl-modified silicone oils, phenylmethyl silicone oils, a-methylstyrene-modified silicone oils, fluorine-modified silicone oils, etc.

Suitable coupling agents include silane coupling agents, titanium coupling agents, aluminate coupling agents, etc., preferably silane coupling agents including organosilicon compounds such as hexamethyl disilazane, butyltrimethoxysilane, hexyltrimethoxysilane, decyltrimethoxysilane, vinyltriethoxysilane, γ-methacryloxypropyltrimethoxysilane, vinyltriacetoxysilane, dimethyldichlorosilane, etc.

Surface-modified magnetite particles of the present invention have the above-mentioned remarkable advantages for the following reasons.

In the process of preparing surface-modified magnetite particles of the present invention, magnetite particles covered with hydrated alumina are positively charged in aqueous solution so that subsequently added (negatively charged) colloidal silica can be electrostatically uniformly bonded to them and said colloidal silica is rapidly adsorbed until it forms one layer but adsorbed no more because the particle surfaces are now negatively charged. During drying, the hydrated alumina forms a compound of aluminium silicate with the colloidal silica, whereby the colloidal silica gels to firmly cover the magnetite particle surfaces. Thus, the present process allows magnetite particles to be automatically covered with a maximum amount of silica so firmly that the silica is scarcely separated even when the magnetite particles are vigorously dispersed by a ultrasonic dispersing machine in a weak alkali solution at pH 9-10.

As a result, the particles can be provided with a high electric resistance of 1×10⁵ Ω·cm or more and a high negative charge of −10 μc/g or less.

Thus obtained magnetite powder is presumed to have minute irregularities on the particle surfaces, ensuring high flowability as indicated by a stirring torque of 0.016 kg·m or less when 100 ml of powder is stirred in a mixing chamber (corresponding to the absorbed meter mixing chamber defined in JIS K6221-1982 available from Flontec).

Such particles treated with at least one of silicones and coupling agents for the purpose of decreasing adsorbed moisture level show better environmental stability as indicated by the adsorbed moisture level of 0.4% or less.

These particles are also industrially advantageous in that they have rather better filtrability than those uncoated with silica because hydrated alumina and colloidal silica are heterogeneously aggregated during the preparation process.

Magnetite powder of the present invention characterized as above are useful for use in electrophotographic magnetic toners, resin-dispersed carriers and resin compositions.

### EXAMPLES

The following examples illustrate the present invention without, however, limiting the same thereto. Test methods used in the examples and comparative examples are as follows.

Electric resistance of powder was determined on 5.0 g of magnetite particles under pressure of 220 kg/cm² by an LCR meter (4261A available from YHP) and corrected for the thickness due to packing of particle powder.

Electric charge of powder was determined on a mixture of magnetite powder and reduced iron powder (TEFV200/300 available from Powdertec) by a blow-off powder charge meter (TB-200 available from Toshiba Chemical).

As an indication of flowability of powder, stirring torque was determined on 100 mL of powder stirred in a mixing chamber (corresponding to the absorbed meter mixing chamber defined in JIS K6221-1982 available from Flontec).

A lower stirring torque is indicative of better flowability.

Moisture content in powder was determined as % by weight at 100° C. using Hiranuma micromoisture meter model AQ-6 (available from Hiranuma Sangyo) based on the Karl Fischer coulometric titration method.

For separation test by ultrasonic dispersion of silica, water of pH 10 is added to treating pigments of 10 g to form a solution of 80 ml for dispersing the pigments for 20 minutes by an ultrasonic homogenizer UH-8-3A, 19 kHz available from Ultrasonic Industry. Then, the magnetite particles are aggregated and precipitated on a magnet, and the supernatant is decanted. The remaining pigment is filtered off, and the filtrate is dried then determined for the amount of silica after ultrasonic dispersion by fluorescent X-ray as compared with the amount before ultrasonic dispersion.

For filtration test, 200 ml of the treated solution at 40° C. under a vacuum of 400 mmHg is filtered through filter paper 5C on a Buchner funnel having a diameter of 110 mm to determine the time until the solution disappear on the funnel.

### Example 1

Magnetite particles having an average particle diameter of 0.26 μm containing 0.80% by weight of silica therein were slurried at 200 g/L. After the slurry was adjusted to pH 11 at room temperature, the pH was gradually lowered to 6 by adding a sodium aluminate solution at 0.5% by weight expressed as alumina on the basis of the weight of magnetite to cover the surfaces of the magnetite particles with a hydrated alumina. Subsequently, colloidal silica SI-50 available from Catalysts & Chemicals Industries Co., Ltd. (particle diameter 19-30 μf) was added at 6% by weight expressed as silica on the basis of the weight of magnetite. The remaining solution was filtered, washed, dried and homogenized according to a standard method. The resulting magnetite powder was determined for separation of silica by ultrasonic dispersion, electric resistance, electric charge, moisture content and powder torque. Measurement results are shown in Table 1. The results showed no separation of silica, high electric resistance, high negative charge and low powder torque.

### Example 2

The procedure of Example 1 was repeated except that the colloidal silica was replaced with colloidal silica SI-550 available from Catalysts & Chemicals Industries Co., Ltd. (particle diameter 4-6 μm) at 2.5% by weight expressed as silica on the basis of the weight of magnetite. Measurement results are shown in Table 1. The results showed less separation of silica, high electric resistance, high negative charge and low powder torque.

### Example 3

The procedure of Example 2 was repeated except that alumina sol-520 available from Nissan Chemical Industries, Ltd. was added as hydrated alumina at 0.5% by weight expressed as alumina on the basis of the weight of magnetite. Measurement results are shown in Table 1. The results showed less separation of silica, high electric resistance, high negative charge and low powder torque.

### Example 4

The procedure of Example 2 was repeated except that 0.2% by weight of a silicone emulsion was added to the slurry after treated in Example 2. Measurement results are shown in Table 1. The results showed less separation of silica, high electric resistance, high negative charge, low powder torque and low moisture content.

### Comparative Example 1

Particles were covered with neither aluminium nor colloidal silica. Measurement results are shown in Table 1. The results showed low electric resistance and insufficient negative charge.

### Comparative Example 2

The procedure of Example 1 was repeated except that particles were not covered with hydrated alumina. Results are shown in Table 1. Colloidal silica was separated by ultrasonic dispersion.

### Comparative Example 3

The procedure of Example 2 was repeated except that colloidal silica in Example 2 was replaced with sodium silicate. Results are shown in Table 1. Only 1.6% of silica was adsorbed and electric resistance was not high. Filtration period was extremely long, i.e. 570 seconds.

TABLE 1

| | Electric | Electric | Powder | Moisture | Adsorbed | Separated | Filtration |
|---|---|---|---|---|---|---|---|
| | resistance | charge | torque | content | silica | silica | period |
| | Ω · cm | μc/g | kg · m | % | % | % | sec |
| Example 1 | 1.3 × 10⁷ | −40 | 0.014 | 0.36 | 5.9 | 0 | 90 |
| Example 2 | 3.1 × 10⁷ | −53 | 0.014 | 0.42 | 2.5 | 0.1 | 80 |
| Example 3 | 7.8 × 10⁶ | −52 | 0.014 | 0.33 | 2.5 | 0.1 | 85 |
| Example 4 | 2.3 × 10⁶ | −60 | 0.013 | 0.26 | 2.5 | 0.1 | 83 |
| Com. ex. 1 | 1.8 × 10⁴ | −5 | 0.021 | 0.22 | — | — | 165 |
| Com. ex. 2 | 1.4 × 10⁶ | −42 | 0.014 | 0.35 | 5.8 | 5.5 | 300 |
| Com. ex. 3 | 8.8 × 10⁴ | −12 | 0.017 | 0.29 | 1.6 | 0.1 | 570 |

What is claimed is:

1. A surface-modified magnetite particle characterized in that the surfaces of magnetite particles are covered with a first layer containing hydrated alumina or alumina sol and the surface of said first layer is further covered with a second layer of silica particles derived from colloidal silica.

2. The surface-modified magnetite particle of claim 1 characterized in that the electric resistance of powder is 1×10⁵ Ω·cm or more.

3. The surface-modified magnetite particle of claim 1 characterized in that the electric charge of powder is −10 μc/g or less.

4. The surface-modified magnetite particle of claim 1 characterized in that the stirring torque is 0.016 kg·m or less.

5. The surface-modified magnetite particle of claim 1 characterized in that the surface of the second layer is covered with a layer of silicone oil and/or coupling agent to have an adsorbed moisture content of 0.4% or less.

6. A process for preparing surface-modified magnetite particles, comprising slurrying magnetite particles with water, then adding a water-soluble aluminium salt or alumina sol at 0.1-3% by weight expressed as alumina to adjust pH to 6-7 and further adding colloidal silica at 0.5-10% by weight expressed as silica to adjust pH to 6-7, followed by filtration, washing and drying.

7. The process of claim 6, further comprising covering the particle surfaces with a silicone oil and/or coupling agent after said colloidal silica is added to adjust pH.

8. The process of claim 6, the water-soluble aluminium salt or alumina sol is added at 0.2-1.5% by weight expressed as alumina.

9. The process of claim 6, the colloidal silica is added at 1-7% by weight expressed as silica.

10. An electrophotographic magnetic toner using the surface-modified magnetic particle of claim 1.

11. A resin-dispersed carrier using the surface-modified magnetic particle of claim 1.

12. A resin composition using the surface-modified magnetic particle of claim 1.
